(19) United States
(12) Patent Application Publication
(10) Pub. No.: US 2002/0042846 A1
(43) Pub. Date: Apr. 11, 2002

(54) Personal support network

(76) Inventors: Gustavo L. Bottan, Lexington, MA (US); Sebastian Ponceliz, Delray Beach, FL (US); Gabriel Dario Obrador, Buenos Aires (AR); Daniel Gustavo Chain, Buenos Aires (AR)

Correspondence Address: CHARLES G. CALL, 68 HORSE POND ROAD, WEST YARMOUTH, MA, 02673-2516, US

(21) Appl. No.: 09/968,053

(22) Filed: Oct. 1, 2001

Related U.S. Application Data
(60) Provisional application No. 60/237,984, filed on Oct. 5, 2000.

(51) Int. Cl. G06F 15/16

(52) U.S. Cl. 709/249; 709/227

(57) ABSTRACT

A system for automating the transmission of notification messages and establishing predetermined communications connections in response to programmable events. The system accepts and stores event description data from each of a plurality of different subscribers. The event description data specifies one or more event types for each of the participating subscribers and, for each given event type associated with a subscriber, further specifies one or more conditions and the destination and content of a notification message to be transmitted when those conditions are satisfied. One or more web database servers may be used to advantage to collect and store subscriber data, permitting each subscriber to interactively add, delete and modify said event description data at any time using a forms-based web interface The subscriber preferably employs the web interface, WAP, voice response and text to speech to provide information suggested by pre-written templates for standardized services, or to create special-purpose functions which meet the subscriber's specific needs.

### CROSS REFERENCE TO RELATED APPLICATION

This application claims the benefit of the filing date of U.S. Provisional Application Ser. No. 60/237,984 filed on Oct. 5, 2000.

### FIELD OF THE INVENTION

This invention relates to information retrieval and communications systems and more particularly to an interactive personal support network for storing and communicating information.

### BACKGROUND OF THE INVENTION

Years ago, people obtained support and help through informal channels: family, friends, neighbors, associates, etc. Small towns and slow-paced life allowed for proper reaction and collaboration in case of need by any individual. Today's fast-paced life in large communities has dissolved the informal and invisible links between people who care and can help an individual. In the best of conditions, modem society provides generic and impersonal emergency services like police, firemen, emergency ambulances, etc. coordinated through generic 911 call services. Such support systems do not provide the caring support that family members and friends can provide. Similarly, industry and other organizations do not normally possess automated systems with the updated and relevant information needed to support remedial or other actions by mobile, distributed or remote individuals, groups, and/or machines (sensors, databases and other data relating equipment).

### SUMMARY OF THE INVENTION

It is an object of the present invention to establish connections between individuals and organizations, friends, family members and providers of support services whenever a predefined need for such connections arises.

It as a further object of the invention to establish connections for furthering business interests between individuals, groups, and organizations.

It is a further object of the invention to respond to events by communicating designated information concerning an individual, an organization or a tangible asset (industrial installations, machines, objects, pets, etc.) to designated persons and service providers in accordance with programmed rules defined in advance by the individual or responsible parties.

It is a further object of the invention to provide an event management tracking record of all communications and progress of remedial action or collaboration between parties, thus allowing for the management of one or multiple events (such as emergencies, malfunctions of equipment, project delays, personnel or product recalls, travel emergencies, etc.).

The present invention includes a secure, interactive personalized information storage and message processing system for accepting tailored information about an individual or asset (called the “subscriber”). The system accepts the identification of persons, assets or service providers from the subscriber, with whom connections are to be established or to whom notifications are to be sent, accepts from the subscriber the definition of rules which specify the conditions under which such connections and notifications are to be activated, and further accepts from the subscriber the identity of the persons or service providers to whom specified items of stored information are to be made available.

Notifications are triggered by defined event messages sent to the personal support network that identify the subscriber and an event type, and that may further specify the location of the subscriber at the time the event message is sent, the identity of the sender, and additional information characterizing the event. The network responds to incoming event messages or signals by applying the stored rules previously accepted from the subscriber to each incoming event message, and by performing actions specified by one or more rules whose conditions are satisfied by the received event message.

In a principal aspect, the present invention is embodied in methods and apparatus for automating the transmission of notification messages and signals. The system accepts and stores event description data from each of a plurality of different subscribers. The event description data specifies one or more event types for each of the participating subscribers and, for each given event type associated with a subscriber, further specifies one or more conditions and the destination and content of a notification message to be transmitted when those conditions are satisfied. A web database server may be used to advantage to collect and store subscriber data, permitting each subscriber to interactively add, delete and modify said event description data at any time using a forms-based web interface. The web server provides subscribers with registration services, information, and instructions of use. Standard functions may be readily implemented using forms-based templates for accepting information such as names, phone numbers and other automated contact information. The subscriber preferably employs the web interface to provide information suggested by pre-written templates for standardized services, or to create special-purpose functions which meet the subscriber's specific needs. The subscriber may request the transmission of a reminder message, typically via email, phone, fax, pager, etc., on a scheduled basis when updating of the defined services should be performed.

In addition to the web interface, means are also preferably provided to allow subscribers to register, provide descriptive data, and establish notification and connectivity services by telephone using touch-tone dialing signals or voice commands to respond to system prompts, or by submitting written forms by facsimile or regular mail.

The system employs an event processing “engine” to receive event messages, signals or other input (“launchers”) from remote locations. Incoming “launchers” designate a specific event type associated with a specific subscriber. In response to receipt of the event message, the system evaluates the stored conditions associated with the event type specified by the event message. If the stored conditions are satisfied, the system responds by transmitting a notification message having the content and destination specified by said event description data for that specific event type. In addition to sending a notification message, the event processing engine may also establish a connection between designated entities allowing them to communicate as needed in response to the event.

As contemplated by the invention, the destination or destinations specified for a given event type may take the form of an email address for email notifications, or a telephone number for telephone, pager or facsimile notifications. The content of the notification message may include specified portions of the personal data supplied by each subscriber, including specific messages written, recorded, taped or registered by any audiovisual means.

The conditions established by the subscriber for an event type may include the specification of the source from which an event message must be sent in order to transmit a notification message, such as the identity of one or more persons and/or the geographic location from whom an event message must be sent in order to transmit a notification message. If desired, an event type may further specify a time range within which the event message must be sent in order to transmit a notification message. The subscriber may also establish conditions by specifying the content of a prompting message delivered to the sender of an event message and the specification of a response which must be supplied by the sender in order to trigger a particular notification message.

The subscriber may define rules to respond to event messages which specify an arbitrarily extensible set of situations, such as:

1. a medical emergency or other event issued by the subscriber or by a family member or a bystander;

2. a request from an authorized family member, friend or service provider to obtain information about the subscriber,

3. a request to establish a communication link with the subscriber or another individual specified by the subscriber; or

4. any other event the subscriber wishes to define by specifying the conditions which characterize the event and the action(s) to be taken when that defined event occurs.

The system contemplated by the invention provides a personalized and temporary network between the parties who can provide assistance or support to the subscriber in a given circumstance. The communications links needed may be established through the public switched telephone network and/or the Internet between fixed or mobile devices. One or more message processing centers provide the “personal support networking engine” for the personal support network and analyze the events defined by incoming messages. The engine then establishes communications links or delivers information in programmed ways to individuals using wired and wireless telephone and Internet devices such as cellular telephones, wireless PDA's, fixed and mobile connecting appliances, and personal computers. The engine accesses rules and data stored in a secure database which is populated by information supplied and controlled exclusively by the subscriber. The system also permits such database information to be combined with other existing and/or specifically developed databases. The engine issues programmed notification messages and establishes connections automatically whenever an event message satisfies the condition part of one or more rules defined and stored in the network's secure database by the subscriber.

The personal support network contemplated by the invention preferably includes a secure web database server which permits a subscriber to interactively add, delete and modify personal information which may be needed by support services when defined events occur. The subscriber further identifies the individuals and services who should be notified, or with whom connections should be established, when defined events occur. In addition, the subscriber specifies the information each such identified support service or individual is entitled to receive. Passwords, or other suitable mechanisms, may be defined by the subscriber to insure that the event messages have been issued by authorized persons, and that the authorized person or service provider to whom information is to be sent has been properly identified. In addition to the secure web-based mechanism for accepting and updating information supplied by the subscriber, other mechanisms can be employed, including telephone interfaces which use touch tone or voice data input, or written forms containing the needed information which are completed and mailed or faxed for entry into the system on behalf of the subscriber.

Additionally, the system contemplated by the invention provides a “Professional Support Network Engine” which can be used to advantage in a commercial situation or in a business-to-business setting. To facilitate entry of the needed personal information and rules definitions, the present invention preferably employs a web database server for presenting one or more questionnaires to the subscriber, prompting the entry of the information and the contact designations which will be needed to handle various classes of typical events. In addition, the subscriber may use the support network's capabilities to accept the free-form definition of, and to provide programmed actions in response to, any event or situation for which the subscriber wishes to define in order to provide an automated response to that event or situation. Subscribers and/or personal support network members with suitable authorization can also enter or retrieve information via touch tone and/or voice recognition and/or text to speech systems.

After the subscriber has entered the information and rules needed to respond to particular events, the support network is ready to handle those events when and if they occur. The occurrence of an event can be communicated to the support network in a variety of ways.

In a particularly valuable mode of operation, the subscriber may use a cellular phone carried on his or her person to trigger the transmission of an event message by simply dialing a predetermined telephone number followed by a touch-tone event code. Both the telephone number and the event code can be stored in advance in the cellular telephone's “autodial memory” for convenient use in an emergency.

The subscriber may also carry an identification card, or wear an identification badge, which provides the access number and one or more event codes which anyone can use to send an event message to the system by telephone. For example, a bystander who happens to be present in the event of an emergency that disables the subscriber may follow simple instructions on the card or badge to send an appropriate event message to the system which will then automatically issue programmed notifications to designated family members, friends or service providers. The card might also include a proximity switch or the like for triggering of an event when positioning the card or proximity switch chip (cellular phone, pager, PDA, etc.) near an enabled receptacle (phone, PDA, PC, Radio, etc.).

When a cellular phone or other device carried by the subscriber is used to issue the notification message, a GPS or MPS positioning system incorporated into the device may be used to transmit the subscriber's geographical position to the support network, along with the subscriber's identification and event type. This location data may be provided to the recipient as part of the notification message, and may also be interpreted by one or more rule conditions to generate different actions depending on the subscriber's geographic position at the time the event occurs. For example, the condition part of one or more rules may be satisfied when the subscriber is in his or her home town while a different set of rules specifying different actions will be satisfied if the subscriber is out of town or even out of the country.

These and other objects and features of the invention will become more apparent by considering the following detailed description of a specific embodiment of the invention. In the course of this description, frequent reference will be made to the attached drawings.

### BRIEF DESCRIPTION OF THE DRAWINGS

FIG. 1 is a data flow diagram illustrating the manner in which event messages are handled in accordance with stored rules defined by the subscriber to communicate designated information to specified recipients;

FIG. 2 is a flow chart illustrating the steps performed during the definition of a rule for handling an event message;

FIG. 3 is a flow chart illustrating the manner in which event messages are handled by the preferred embodiment of the invention; and

FIG. 4 is a schematic block diagram illustrating the principle components used in a preferred implementation of the personal support network contemplated by the invention.

### DETAILED DESCRIPTION

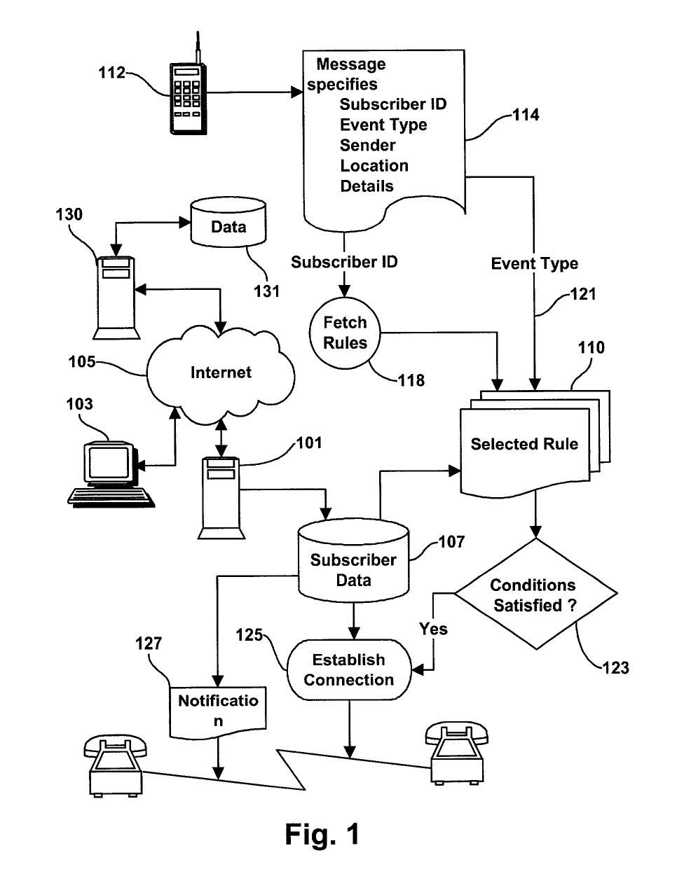

The personal service network contemplated by the invention preferably employs an Internet web database server as illustrated at 101 in FIG. 1 to collect personal data from each subscriber. Each subscriber registers by using a conventional web browser seen at 103 or alternatively through a wireless PDA, touch tone phone, wireless smart card or wireless phone devices provided with appropriate web interfaces to connect to the server 101 via the Internet 105 and completes HTML or similar forms to populate the database 107 with personal data. The web database server 101 preferably takes the form of a relational database provided with built-in web interface functionality, such as the Oracle 8i database management system available from Oracle Corporation of Redwood Shores, Calif., or equivalent.

The personal information database employs a standard schema for storing a robust collection of personal information about each subscriber in a predetermined format as outlined generally below and illustrated in further detail in the attached Appendix. The predetermined data fields listed below as examples (not all of which are used by every subscriber) may be supplemented by user-defined data fields.

1. Personal Data

1.1 Date of birth

1.2 Place of birth

1.3 Married to

1.4 Children

1.5 Parents

1.6 Military service

1.7 Safe deposit boxes

1.8 Postal boxes

1.9 Employment history

1.10 Real Estate Property

1.11 Personal Property

1.12 Bank deposits

1.13 Securities

1.14 Insurance policies

1.15 Other property

1.16 Liabilities

1.17 Tax records

2. Medical

2.1 General information

2.1.1 Weight

2.1.2 Height

2.1.3 Birthmarks and defects

2.1.4 Allergies

2.2 Emergency contacts

2.2.1 Family member(s)

2.2.2 Friend(s)

2.2.3 Physician(s)

2.2.4 Dentist(s)

2.2.5 Pharmacist(s)

2.2.6 Clergy

2.3 Immunization Records

2.4 History

2.4.1 Last Physical Exam

2.4.2 Last Eye Exam

2.4.3 Last Dental Exam

2.4.4 Health History (See Appendix I)

2.5 Regimens

2.5.1 Nutrition Program

2.5.2 Exercise Program

2.5.3 Medications

2.5.3)1 Name

2.5.3)2 Dosage

2.5.3)3 Frequency

2.5.3)4 Physician

2.5.3)5 Pharmacy

2.5.3)6 Comments

3. Legal

3.1 Legal residence

3.2 Citizenship information

3.3 Will

3.3.1 Date executed

3.3.2 Current location

3.3.3 Attorney

3.3.4 Executor

3.3.5 Guardians of children

3.3.6 Witnesses

As seen in the list above, the personal data includes the identification of people and support service provides who may need to be contacted in the event of an emergency. Accordingly, for each such person, phone numbers, fax numbers, mailing addresses and email addresses are included in the data to facilitate automated notifications as contemplated by the invention. These contacts may include:

4. Affective Support Contacts:

4.1 Family

4.2 Friends

5. Professional Support Contacts:

5.1 Health care professionals

5.2 Lawyers

5.3 Accountants and financial advisors

5.4 Other professionals

6. Utilitarian Support Contacts:

6.1 Neighbors

6.2 Support groups

6.3 Service providers

The information provided by the subscriber will have different levels of confidentiality. Some will be for all to see. For example, an individual might want blood type, allergies to medicines and other emergency information to be readily available to everyone involved in an emergency. Other medical information, assuming the user wants to store it in the system, would be accessible only by those with authorization i.e. personal physician, etc. Similarly, all modules of information will be independent. Thus medical information to be used in an emergency would not be accessible by those who are in the network for other purposes. For example, personal information on a will, instructions to family members upon death of the user, etc. will only be accessible to those who have been authorized by the user to have access to this information during the handling of selected events.

In general, the kinds of information to be made available to a given recipient are specified in the rules defined by the subscriber for governing the handling of events.

As seen in FIG. 1, in addition to specifying personal data, the subscriber also uses his or her web browser 103 to complete rule definitions illustrated at 110 in FIG. 1 and stored in the database 107. These rules govern the handling of events communicated to the network. By way of example, an event may be transmitted to the support network by the cellular phone 112 which transmits a message by dialing a predetermined telephone number.

The content of this “event message”, illustrated at 114 in FIG. 1, specifies a particular subscriber and event type, as well as additional information. If the subscriber's own cellular phone is used to send an event message by dialing a predetermined access number, the network's caller ID mechanism can be used to identify the subscriber, and an automatically triggered touch tone code from the cellular phone 112 may be sent to specify the event type. For example, a subscriber suffering from a heart disorder may create a “possible heart attack” event which is assigned a touch tone code which, when received from that subscriber, automatically triggers notifications to one or more family members or friends, with a further notification being sent the subscriber's physician.

Using the MPS (mobile positioning system) or a GPS (global positioning system) device, the message may further automatically include the coordinates of the sender's current geographic location. Additional information, such as the identification of the sender (who need not be the subscriber) and any additional information of value in connection with the particular event may be also included in the message. For selected events, the caller may be requested to dictate a recorded message which may then be relayed, with other information, to designated persons.

Specific illustrative examples of events which may be defined by a subscriber and handled by the network are illustrated by the following scenarios:

Case A:

The subscriber faints on the street. A bystander helps. If the subscriber is carrying a cellular phone, pressing of a single autodial button will trigger the emergency network as noted above. The bystander will be able to dictate a recorded “voice mail” message describing what is happening, even if he/she does not know the identity of the subscriber. This voice mail message may then be combined with needed information from the subscriber's personal database and sent to designated people or service providers. If no cellular phone is available, a toll-free number may be to be used from any public phone. As the subscriber is sent by ambulance to a hospital, different people can use the phone system to describe where the subscriber is, the subscriber's status and any other pertinent information. Because the system automatically forwarded a warning and provides connectivity to a personal physician and family members, they can hear the status of events and can immediately take action to aid the user. Because the product includes GPS positioning and mapping there is further information on the whereabouts of the subscriber.

Case B:

The subscriber or a family member has a car accident. There is no medical emergency but the accident has caused damage to others. The police may intervene and the subscriber (or family member) may be taken in custody. A telephone call to the network will then trigger the engine to automatically attempt to connect to caller with the family lawyer and others who will take action to support the subscriber or family member.

Case C:

The subscriber's children are on-route home from school, driven by a neighbor. The child's mother, believing she was to pick-up her child that day, but being unable to find the child, can call the network and leave a voice mail message that will be automatically relayed to designated friends and neighbors to be on the lookout for the child. Then, when the child is delivered to the home, a neighbor may notify the mother the child has been found and provide care until the mother returns.

Case D:

A foreigner stationed in a new destination does not know the ways of the place or speaks the language. His or her well being may be totally dependent on the ability to use the support network to communicate with family, co-nationals, and work colleagues. Such personalized network could include local as well as remote members. For example a German national working in Saudi Arabia. Upon an emergency, not just local action could be taken but also support from the home country, including action to take the individual to its home country.

Case E:

An individual is by herself/himself at home and feels uncomfortable with being alone, whether it is an affective issue or feels threaten by the potential of crime in the neighborhood. The personal support network could accept a dictated message and automatically communicate that message to neighbors, family members and the local police.

Case F:

An individual within an organization learns about a success case in its business and triggers a communication event to his/her predefined business network. For example, key clients. This is complemented by other input regarding business needs or information from others, this is then communicated to other personnel who can use this to their and their company advantage, add information and interact with other peers through information communication and rule setting.

Case G:

An individual or group faces an ecological emergency. Such event is met by a series of actions as prescribed in the company's operations manual. Instead through the Personal Support Network (PSN) system or through the peer-to-peer “Professional Support Network Engine”, the individual can set these rules into the PSN engine and thereafter advise, communicate, link, and set in motion all necessary actions required to deal with the triggering event. Although the foregoing examples illustrate possible uses of the personal support network contemplated by the example, it is to be understood that the events which are handled by the network are defined by each subscriber and customized to best meet that subscriber's needs.

Case H:

Personnel or Product Recalls.

A military organization needs to call their members back to the base. An authorized person or system “launcher” must match predefined rules or authentication and thereafter triggers the recall. Further set of predefined rules will then reach each member. The progress of the calls and the identification of the status of notifications, receipt, confirmation, actions taken, etc. can be instantly displayed in the log, which the manager of the event can access via Internet or other visual methods.

A similar system can be used in a school setting. Here, a School Superintendent needs to delay or cancel school due to a snow emergency. The input coming from the boilers at the schools indicate the boilers are down. The town's public works issues a notification indicating the bad conditions of the roads. Based on these and other inputs the Superintendent can trigger the “school cancellation event” which automatically reaches staff, parents and any individual or organizations in need to know. The Superintendent can monitor the progress by checking his/her webbrowser.

Case I:

Industrial/Business Emergency Management.

A chemical plant has a spill or explosion. A worker nearby is the first to witness the situation and immediately presses an emergency button in its cellular phone, radio or other communication device. The emergency event is triggered and the necessary parties are instantly notified and connected to coordinate their response. Information about the chemicals stored in the tank and its proper handling or other important information is made available instantly to all parties in need to know.

Case J:

Logistic Support:

A machine, engine, or any other asset is malfunctioning or is in need of attention. The specialized and/or trusted parties are immediately connected and can start coordinating their response. The triggering can be through a person who decides to trigger the event or is triggered by analyzing the signal coming from instrumentation or other monitoring devices.

Case K:

Project Management/R&D Support.

A team is working on different tasks. Many of the delays in a project, usually 25% may result from the lack of preparation of teams during the “hand-off” of tasks along the critical path of the project. The monitoring of the status of project advance is usually registered through project management software and tools and the information stored in a database. Input from this database can notify and keep all parties aware of the progress and also be reminded of hand-offs.

Case L:

Pet Support.

Pets are usually registered and tattooed or a chip inserted under their skin. When lost, either their collar tag, tattoo or chip signal can provide information about the owner. The system enhances the care of pets by allowing any of these identification methods to be used by any party who finds a missing pet or a pet in need of attention and trigger an event by which the owner is notified no matter where they might be. Similarly the vet and town animal officer may automatically be notified in a way that all parties can coordinate help to the animal.

Case M:

Matching/Dating.

Most dating systems today try to match people through personal interviews and decision makers or else take advantage of the internet or on-line dating systems. These can be enhanced by allowing the input from databases to match corresponding criteria to trigger alerts and advice potential parties of compatibility. Rather than risking a first blind date, the system allows them to communicate via PSN system until they decide to meet or else abandon the relation without danger of embarrassment or unknown risk.

When the event message 114 is received, the subscriber ID included in the message content is used to access the set of rules 110 previously established for the identified subscriber as illustrated at 118. The event type code included in the message is then used to identify one or more rules dealing with that identified event type as illustrated at 121. For each rule dealing with the identified event type for the identified subscriber, the content of the incoming message is compared with the conditions specified in the given rule to determine if the event satisfies those conditions as shown at 123 and described in more detail later in connection with FIG. 3. If the rule's conditions are satisfied, designated telephone or Internet connections are established as indicated at 125, and information content from the subscriber database and/or the incoming message 114 is included in a notification 127 sent via the established connection.

In the arrangement described above, the Internet web database server 101 which populates the subscriber database 107 operates on a client-server basis with user appliances, such as a browser program executing on the PC 103, or with PDAs and cellular phones connected via a WAP gateway and the Internet to the server 101. Event messages which are processed by the system can be transmitted to the central host via the public switched telephone network (PSTN), via the Internet, radio/TV waves, or by any other suitable transmission pathway.

In addition, or alternatively, the personal support network contemplated by the invention may be implemented using a distributed or peer-to-peer architecture as illustrated by the additional processor 130 and its connected database 131 in FIG. 1. In a peer-to-peer system, all processing and data storage is not provided by a single centralized database server but may distributed among other servers, as well as by the internal processing and storage capabilities of users' appliances, personal computers, PDAs, or other devices. For example, a user device may be programmed to process events in accordance with locally stored rules in order to establish selected connections directly from the user device, or via a nearby communications device controlled via a Bluetooth™ radio link by the user device that processes the event. By making use of the local processing and communications capabilities built into the user devices, or in other devices locally accessible to the user device, rule storage and event processing, including programmed actions specified by locally stored rules, may be performed where appropriate. In addition, rules may be locally stored in a client device and transmitted with event messages when they occur for remote processing by a server. As still another alternative, locally stored rules may be used to locally process event messages at the user device to cause commands to be issued to a remote processor for executing operations specified by the locally stored rules.

Rule Definition Procedure

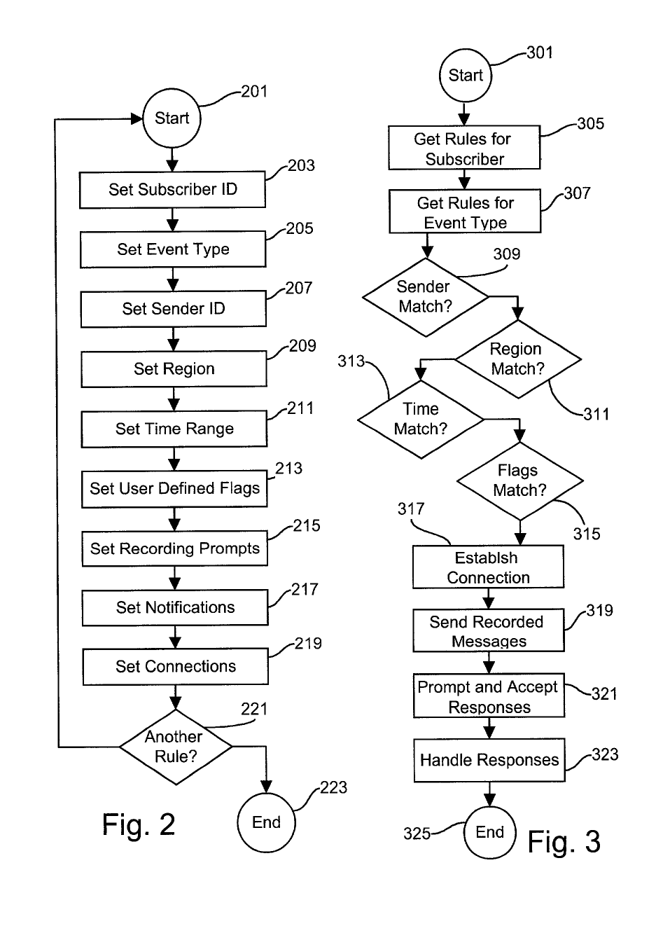

The manner in which event handling rules are defined by the user is illustrated by the flow chart seen in FIG. 2. Each rule is defined by a set of steps beginning at 201. The rules definition process is preferably performed after the subscriber has logged into the network's web site with a proper password to ensure that the changes to be made to the subscriber's file of personal information and rules is authorized. This process yields the subscriber identification value which forms part of the rule definition as indicated at 203. The subscriber then selects an event type from a menu of standard event types, or specifies a new event type, as indicated at 205. Each standard event type when selected causes one or more web forms to be presented to the subscriber that are pre-written to prompt the subscriber for the special information needed to handle common situations, such as medical emergencies, missing family members, possible home invasions, and the like. Such pre-written forms help subscribers to define rules which are best calculated to effectively deal with common problems. It should be understood, however, that the network is in no sense limited to the functionality provided by such pre-written event handling procedures. The rules definition process also allows the subscriber to define customized rules (event handlers) by specifying both the conditions that trigger actions, and the nature of those actions. Thus, in addition to selecting from a list of predefined event types, a subscriber may create and name a new event type at 205.

Some events may be triggered only by particular persons whose identity is set at 207. The process of identifying one or more persons authorized to trigger a particular event may be accompanied by the entry of a password value which can be matched against a password presented by a message sender to insure the identity of a sender specified at step 207. All ID numbers and codes may be linked to a “names” database or server to provide “name friendly” identification instead of a number or code, at the choice of the subscriber or authorized user.

Some events may be conditioned on the presence of the sender in a particular region (such as the subscriber's home town). A cellular phone, PDA or other mobile device used to send event messages to the network might advantageously include a built-in GPS (Global Positioning System) receiver for continuously or periodically updating location data for that device which is transmitted with the event message when sent. For details on the Global Positioning System and GPS receivers, see Understanding GPS: Principles and Applications by Elliott D. Kaplan (Editor), Artech House; ISBN 0890067937 (1996). In addition, Mobile Positioning Systems (MPS) incorporated into cellular telephones provide a mechanism for continuously or periodically updating location information for those devices. MPS technology is similar to the satellite-based Global Positioning Systems (GPS) but offers the additional capability of determining location inside buildings, parking garages and other shielded areas such as inside a pocket or briefcase that are inaccessible to GPS systems. MPS Mobile Positioning Systems for GSM cellular phones are offered by Erickson and Cellpoint, Inc.As indicated at 209, the subscriber may define the boundaries of a region within which geographic coordinates sent with an event message must reside in order to trigger the event handler. Such region and location data is preferably stored in a standard format, such as that used by the locator feature in Oracle8i interMedia, a component of the Oracle 8iJ database available from Oracle Corporation, Redwood Shores, Calif. In addition, Oracle Spatial, and its extensions used with the Oracle8i Enterprise Edition product, provides an integrated set of functions and procedures that enables spatial data to be stored, accessed, and analyzed quickly and efficiently in an Oracle8i database. Oracle Spatial provides a SQL schema and functions that facilitate the storage, retrieval, update, and query of collections of spatial features in an Oracle8i database, and includes the following components:

a. A schema that prescribes the storage, syntax, and semantics of supported geometric data types;

b. A spatial indexing mechanism;

c. A set of operators and functions for performing area-of-interest and spatial join queries; and

c. Administrative utilities.

For more detailed information, see “Oracle8i interMedia Audio, Image, and Video User's Guide and Reference” Release 8.1.5 Oracle Corporation (Oracle Part No. A67299-01), 1999, and Oracle Spatial User's Guide and Reference, Release 8.1.6, (Oracle Part No. A77132-01), 1997.

A given event may further be required to occur within specific date and time limits, such as particular days of the week, particular times of the day, or only before or after a particular date or time. These time limits are set by the subscriber for each rule at 211.

As seen at 213, the subscriber may further define arbitrary conditions, here called “flags”, by entering the value of a prompting string which requests a boolean value (“Yes” or “No”) from the sender, or which requests the sender to provide a numeric or string value. In the latter case, the subscriber further defines the range of each such value which is to be deemed to satisfy the condition expressed by the flag. For example, a subscriber might define a flag by specifying the prompt “What is your age?” and then provide different actions based on the sender's response. As another example, the prompt may request an authorization password string from the sender which must match a preset string if the flag condition in the rule is to be satisfied. Note that, in prewritten template questionnaires for standard event types, such flag conditions may be suggested as defaults which may be accepted or rejected by the subscriber at step 213.

At step 215, the subscriber may specify that each message of the type which satisfies the rule being defined should include a dictated (or keyboarded) message from the sender. To do that, the subscriber enters a prompt or question that is presented to the sender at the time the message is being sent. For example, the prompt simply state “At the tone, please record any message you wish to send”, or it may request specific information, such as “At the sound of the tone, please describe the subject's physical condition for the attending doctor”.

The prompts which are presented to the sender at 213 and 215 may be converted from entered text into audio form by speech synthesis, or may be uploaded as voice file prompts dictated by the subscriber, for presentation to a sender who accesses the system by telephone. As noted below, certain incoming events may be handled by human operators employed by the support network, in which case the entered prompts may be displayed to the human operator who may then read them as part of a written script designed to obtain needed information from a caller, including obtaining the needed event type designation at 205, an identification of the sender at 207, and the location of the sender at 209. This conversation between the caller and the human operator may be recorded and relayed in whole or in part with the notification message sent to designated recipients.At step 217 of the rules definition procedure illustrated in FIG. 2, the subscriber is given the opportunity to define the destination and content of notification messages which are to be sent when the conditions specified by the rule being defined are satisfied. The notification definition includes a specification of each recipient of the notification, the manner of delivery, and the content of the notification.

Recipients may be conveniently specified from a standard address book of contacts established when the personal data was entered into the database as discussed earlier. An email address, a telephone number, a fax number, or a mailing address may be specified for each recipient, and the notification may accordingly be sent by email, by telephoning a recorded voice message (or by a human operator calling the recipient and delivering the message conversationally), or by fax, or by mailing the notification. The subscriber may define one or more methods for each, with less direct mechanisms being used only if a more direct method is unsuccessful. For example, the subscriber may specify that, in the event of a medical emergency, the subscriber's designated physician should be notified first by telephone, and if that fails by both facsimile transmission and by email. Email messages may attach voice messages as audio files in a standard format, such as MP3. Where the form of communication does not readily permit the transmission of information in a particular form; for example, when a voice mail message has been created by the sender but the most direct available method of transmission is a faxed notification, the voice mail message may be made available in recorded form (e.g., as a downloadable streaming audio file) at a predetermined URL on the network's web site, and the fax transmission to the recipient may state that URL so that the recipient can use a web browser to obtain the more complete message via the Internet.At step 217, the subscriber may also provide the recipient with designated portions of the data available in the subscriber's personal database. Thus, for example, the subscriber may specify that, in the event he or she becomes seriously disabled, designated information from the subscriber's personal record is to be automatically sent by fax or mail to the subscriber's attorney, accountant, and the executor of his will. As part of the network's standard event templates, information which is likely to be needed, together with the default text of a notification message and a default selection of appropriate recipients, will be provided to the subscriber as a draft event template during the rule definition process, during which the subscriber can modify the default selections as he or she sees fit.

As seen at step 219 in FIG. 2, in addition to transmitting information in notification messages to designated recipients, the subscriber may define connections which should be established between designated persons in certain situations. For example, a subscriber may wish to establish an immediate communication link between a close family member and the family physician in the event of a medical emergency. These connections are defined at step 219 by specifying one or more participants in a “conference call” which is to be automatically established by the system. Once this conference call connection has been established, the information defined by the subscriber is automatically made available to the conference call participants, either in voice mail form, or by indicating a URL from which the information may be obtained upon the presentation of a suitable password. Note that the creation and handling of such notification web pages may be performed under program control by the web server 101 using the information contained in the subscribers database (as specified at 217) and from the content of the event message.

After each rule has been fully defined, the subscriber is given the opportunity to create additional rules as noted at 221. Note that all of the conditions specified in a rule must be satisfied by a given event before the notifications or connections specified by the action part of each rule are attempted. In order to simplify the creation of alternative conditions, the network preferably provides a convenient mechanism for repeating steps 205 to 211 to set up alternative sets of conditions for specifying the content and destination of the notifications and connections specified by the subscriber in steps 213-219.

Notifications to the Personal Support Network:

The contacts chosen by the subscriber to form part of the Personal Support Network receive an automatic notification via email, phone, fax, pager, etc., of their inclusion in the system. They have the opportunity to accept or decline, thus advising the subscriber for follow-up (i.e. allowing him/her to include new contacts to replace those who did not want to be part of the network).

Update of Information:

All PSN members and subscribers can select the mode and frequency of contact to be reminded to update their contact and other pertinent data. This is a key feature because it decentralizes the updating function, which is normally the case with most systems. This allows a more accurate and relevant information system.

Event Message Processing

The personal support network contemplated by the invention handles incoming event messages following the procedure generally illustrated in FIG. 3 of the drawings.

When an incoming message arrives as indicated at 301, the identify of the particular subscriber contained in the message is used to fetch the rule definitions applicable to that subscriber as indicated at 305, and the event type code included in the message is used to restrict the set of rules that must be compared with the incoming message content to only those rules which are designed to handle the designated event type as indicated at 307.

If a given rule for that event type specifies a particular sender, a test is performed at 309 to determine if the sender identified in the message matches the specified sender. If not, the rule is discarded. If no sender is specified, or if the sender matches a sender specified by the rule, the test at 311 is performed to determine whether, if a region has been specified in the rule, the location specified by the message is within that region.

At 313, if the rule specifies a time range within which a given message must be sent (or received), a test is perform to determine if that time condition is satisfied.

At 315, if one or more flag conditions were established for the rule as discussed earlier in connection with step 213 in FIG. 2, test(s) are performed to determine whether the condition(s) specified by these flag(s) are satisfied.

If all of the conditions have been satisfied for a given rule, the system will then attempt to establish the connections specified by the rule at step 317, will send the content of any designated information from the database or from the incoming message to the designated recipients with whom connections are established at 319, and will prompt the recipient for response data at 321 and handle those responses at 323. When these actions are completed at 325, the engine will then return control to step 309 to process any additional rules created by the identified subscriber for the event type specified in the incoming message. The engine also allows members of the support network to continue to leave and retrieve messages from each other or external parties as the case may require. In this way the PSN members coordinate and efficiently perform joint activities.

System Components

As noted above, the network preferably employs a web database server 101 to provide a web site through which the subscriber can register, provide personal information and define rules which govern the operation of the subscribers personal support network. This web site provides templates which include information of use for different emergencies, and allows the user to specify names, phone numbers, email addresses and other contact information for designated persons who are to be made part of the personal support network. The web site published by server 101 further allows the user to alter the stored information and rules at any time, and provides an e-commerce platform for credit card payment for services provided by the network and allied service providers.

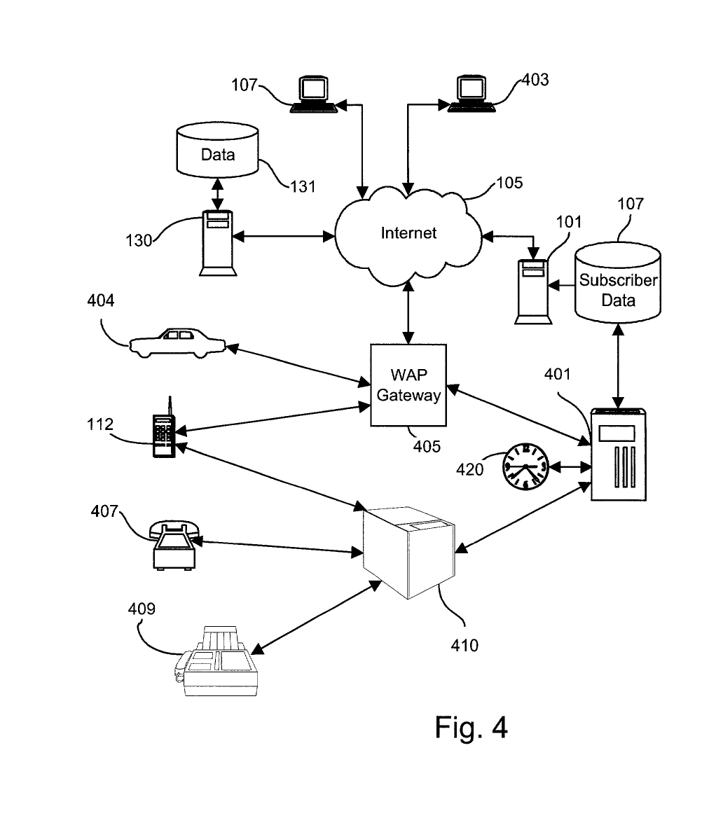

The hardware components used to implement telecommunications for the network are illustrated in FIG. 4 of the drawings. A processor seen at 401 in FIG. 4 operates as the “engine” for the message processing system, and may be the same or different computer from the computer which acts as the web server seen at 101. The engine 401 processes information and connects remote parties as described below.

The processor 401 accesses the subscriber database 107 that is populated by the subscriber via web server 101 as discussed earlier. Incoming event messages may arrive from a variety of sources including:

1. Email messages from a POP server (not shown) connected to the Internet;

2. Data signals and/or messages from web browsers as illustrated at 107 and 403, or from other computers (of all kinds) including sensors of any kind, which share data or processing tasks on a distributed basis as discussed earlier in connection with processor 130 and database 131 also shown in FIG. 1. These data messages may be sent via the Internet using any suitable protocol, including HTTP and FTP, or others.

3. Data messages from or between “mini-browsers” in cellular phones, PDAs and other portable devices using a Wireless Application Protocol (WAP) connection established between the portable devices, as illustrated by the mobile and cellular phones at 404 and 112 respectively and the WAP gateway at 405 which is in turn connected using an HTTP Internet connection to the web server 101. The WAP protocol has been widely implemented for a variety of mobile and portable devices, and detailed specifications describing the WAP protocol as promulgated by The Wireless Application Forum, Ltd. are available on the World Wide Web at www.wapforum.org.

4. Telephone messages via the dialup telephone system from a cellular phone as illustrated at 112, or a conventional telephone as illustrated at 407. Incoming phone calls, and transmitted touch-tone event codes and other data, may be automatically handled using an automatic call distributor (ACD) seen at 410 which operates under the supervisory control of the processing engine 401 and handles both incoming and outgoing. Automatic call management hardware and software is available from a variety of sources, including systems employing the Dialogic CT Connect Server available from Dialogic Corporation of Parsippany, N.J. The CT Connect system gathers all the CT resources into a common server, making them part of the enterprise's information infrastructure. In its simplest form, the CT server physically contains all of the enterprise's CT resources. Applications needing media processing and/or call control resources request the services they need from the ACD 410. The CT infrastructure provides standard interfaces such as the Microsoft Telephony Application Programming Interface (TAPI), the Enterprise Computer Telephony Forum (ECTF) S.100, and the ECMA Computer Supported Telephony Application (CSTA). The engine 401 manipulates calls by calling CT server resources. The CT server provides the functionality of an automatic call distributor (ACD) which may alternatively be provided in the traditional way by a standalone ACD system. The ACD system 410 allows the remote input of digital, touch-tone and voice information and relays it accordingly.

Outgoing notifications and conference calls to cellular phones as illustrated at 112 or conventional telephones as illustrated 407 are established using public switched telephone network (PSTN) connections established by means of the ACD 410 operating under the control of the engine 401. Facsimile transmissions to a designated fax machine as illustrated at 409, or messages to a paging system, may also be sent using dialup or Internet connections established by the ACD 410 or by the web server 101 respectively. Outgoing email messages are handled by the web server 101 using the SMTP protocol. As noted earlier, connections between the web server 101 and the portable devices may be established through a WAP gateway 405.

Conference “Partnering” System

The present invention may be used to help people attending trade shows, conventions and conferences to contact others having mutual interests. In advance of the meeting, each participant submits information describing themselves as well as the desired attributes of those who they wish to contact. At or before the meeting, the event processing engine matches the desired attributes of others as submitted by each participant against the data describing other participants. When a match occurs between the needs of a first participant and the attributes of a second participant, a notification messages may be sent to the participant, providing information about the other participant, including an email address and/or telephone number which may be used to schedule a meeting.

Both the participant's personal information and the attributes of others whom the participant would like to contact are preferably entered into a central database using a Web server which presents and accepts “fill in the blanks” HTML forms to the participant. The user is preferably presented with a set of check boxes and/or radio buttons which identify who the participant is and the attributes of the products, services, or information sought. In addition, the participant may indicate the times when he or she will be available to meet with “matching” participants, either during the meeting or afterwards.

When a match is made, the event engine preferably sends an email message to the participant, providing information about the potential contact. When multiple matches are found, all may be listed in a single email. When a participant registers after the initial matching is performed, the characteristics and desires of the late registrant may be matched against the existing database, and additional notification messages may sent to when a matches are found. An automated phone call to the number provided by the participant (usually a cellular or office phone number), informing him or her that a match was made and that an e-mail is waiting, may be sent.

Conclusion

It is to be understood that the preferred embodiment of the invention that has been described is merely an illustrative application of the principles of the invention. Numerous modifications may be made to the methods and apparatus which have been disclosed without departing from the true spirit and scope of the invention.

What is claimed is:

1. The method for automating the transmission of notification messages comprising, in combination, the steps of:
accepting and storing event description data from each of a plurality of different subscribers, said event description data specifying one or more event types for each of said subscribers and, for each given one of said event types, further specifying one or more conditions and the destination and content of a notification message to be transmitted when said one or more conditions are satisfied,
receiving an event message from a remote location, said event message designating a specific event type associated with a specific subscriber,
retrieving and evaluating the one or more stored conditions associated with said specific event type and, if said one or more stored conditions are satisfied, transmitting a notification message having the content and destination specified by said event description data for said specific event type.

2. The method set forth in claim 1 further including the steps of receiving and storing personal information from each of said plurality of subscribers and wherein said content specified by said event description data includes a selected portion of said personal information received from the subscriber associated with said specific event type.

3. The method set forth in claim 1 wherein said destination specified by said event description is an email address enabling said notification message to be sent by email.

4. The method set forth in claim 1 wherein said destination specified by said event description is a telephone number enabling said notification message to be sent via the public switched telephone network.

5. The method set forth in claim 1 wherein said step of receiving said event message from a remote location comprises the step of receiving an incoming telephone call via the public switched telephone network.

6. The method set forth in claim 5 including the further step of receiving dialing signals designating a specific event type associated with a specific subscriber via said public switched telephone network.

7. The method set forth in claim 1 wherein said steps of accepting and storing event description data from each of a plurality of different subscribers are performed via the Internet using a web database server which permits each subscriber to interactively add, delete and modify said event description data.

8. The method set forth in claim 1 wherein said one or more conditions include the specification of information describing the source from which an event message must be sent in order to transmit a notification message.

9. The method set forth in claim 8 wherein said information describing the source from which an event message must be sent identifies one or more persons from whom an event message must be sent in order to transmit a notification message.

10. The method set forth in claim 8 wherein said information describing the source from which an event message must be sent identifies the geographic location from which an event message must be sent in order to transmit a notification message.

11. The method set forth in claim 1 wherein said one or more conditions include the specification of a time range within which the event message must be sent in order to transmit a notification message.

12. The method set forth in claim 1 wherein said one or more conditions include the specification of the content of a prompting message delivered to the sender of an event message and the specification of the content of a response to the prompting message which must be supplied by the sender in order to transmit a notification message.

13. The method set forth in claim 1 wherein one or more of said conditions identify the attributes of participants with whom said specific participant desires to communicate and wherein said step of retrieving and evaluating the one or more stored conditions associated with said specific event type includes the step of comparing said attributes with said descriptive data received from participants other than said specific participant and transmitting a notification message to said specific participant containing information describing other participants matching some or all of said attributes.

14. Apparatus for automating communications functions in response to programmable events comprising, in combination:
a database system for accepting and storing event description data from each of a plurality of different participants, said event description data specifying one or more event types for each of said participants and, for each given one of said event types, further specifying one or more conditions and the destination and content of a notification message to be transmitted when said one or more conditions are satisfied, and
an event processing engine for receiving an event message from a remote location,
said event message designating a specific event type associated with a specific participant, said event processing engine including means for retrieving and evaluating the one or more stored conditions associated with said specific event type and, if said one or more stored conditions are satisfied, transmitting a notification message having the content and destination specified by said event description data for said specific event type.

15. Apparatus as set forth in claim 14 wherein said database system further includes means for receiving and storing personal information from each of said plurality of participants and wherein said content specified by said event description data includes a selected portion of said personal information received from the participant associated with said specific event type.

16. Apparatus as set forth in claim 14 wherein said destination specified by said event description is an email address enabling said notification message to be sent by email.

17. Apparatus as set forth in claim 14 wherein said destination specified by said event description is a telephone number enabling said notification message to be sent via the public switched telephone network.

18. Apparatus set forth in claim 14 wherein said means for receiving said event message from a remote location includes means for receiving an incoming telephone call via the public switched telephone network.

19. Apparatus as set forth in claim 18 wherein said means for receiving said event message includes means for receiving dialing signals designating a specific event type associated with a specific participant via said public switched telephone network.

20. Apparatus as set forth in claim 14 wherein said database system for accepting and storing event description data from each of a plurality of different participants includes a web database server connected to said participants via the Internet which permits each participant to interactively add, delete and modify said event description data.

21. Apparatus as set forth in claim 14 wherein said one or more conditions include the specification of information describing the source from which an event message must be sent in order to transmit a notification message.

22. Apparatus as set forth in claim 21 wherein said information describing the source from which an event message must be sent identifies one or more persons from whom an event message must be sent in order to transmit a notification message.

23. Apparatus as set forth in claim 21 wherein said information describing the source from which an event message must be sent identifies the geographic location from which an event message must be sent in order to transmit a notification message.

24. Apparatus as set forth in claim 14 wherein said one or more conditions include the specification of a time range within which the event message must be sent in order to transmit a notification message.

25. Apparatus as set forth in claim 14 wherein said one or more conditions include the specification of the content of a prompting message delivered to the sender of an event message and the specification of the content of a response to the prompting message which must be supplied by the sender in order to transmit a notification message.

26. Apparatus as set forth in claim 14 wherein one or more of said conditions identify the attributes of participants with whom said specific participant desires to communicate and wherein said event processing engine includes means for comparing said attributes with said descriptive data received from participants other than said specific participant and for transmitting a notification message to said specific participant containing information describing other participants matching some or all of said attributes.
